(19) United States
(12) Patent Application Publication
(10) Pub. No.: US 2015/0140420 A1
(43) Pub. Date: May 21, 2015

(54) METHOD FOR MANUFACTURING CARBON-SULFUR COMPOSITE, CARBON-SULFUR COMPOSITE MANUFACTURED THEREBY, AND ELECTROCHEMICAL DEVICE INCLUDING THE SAME

(71) Applicant: IUCF-HYU (INDUSTRY-UNIVERSITY COOPERATION FOUNDATION HANYANG UNIVERSITY, Seongdong-gu, Seoul (KR)

(72) Inventors: Yang-Kook Sun, Seoul (KR); Dong Ju Lee, Changwon-si (KR); Ju Won Park, Seoul (KR)

(73) Assignee: IUCF-HYU (INUSTRY-UNIVERSITY COOPERATION FOUNDATIO HANYANG UNIVERSITY, Seongdong-gu, Seoul (KR)

(21) Appl. No.: 14/398,671

(22) PCT Filed: May 2, 2013
(86) PCT No.: PCT/KR2013/003823

§ 371 Date: Nov. 3, 2014

(30) Foreign Application Priority Data
May 3, 2012 (KR) 10-2012-0047023

(51) Int. Cl. H01M 4/36; H01M 4/04; H01M 10/0568; H01M 10/052; H01M 10/0569

(52) U.S. Cl. CPC H01M 4/364; H01M 10/052; H01M 10/0569; H01M 10/0568; H01M 4/366; H01M 4/04; H01M 2300/0025
USPC 429/188; 429/231.8; 216/39

(57) ABSTRACT

The present invention relates to a method for manufacturing a carbon-sulfur composite, a carbon-sulfur composite manufactured by the method, and an electrochemical device including the same. Since the carbon-sulfur composite manufactured by the carbon-sulfur composite manufacturing method of the present invention includes the hollow carbon ball having the inner hollow which is uniformly filled with sulfur, a sulfur content increases to increase a capacity characteristic increases. In addition, even though sulfur is changed into a liquid state during charge and discharge processes, an electrode structure is not destroyed to realize a stable lifetime characteristic.

### TECHNICAL FIELD

The present invention relates to a method for manufacturing a carbon-sulfur composite, a carbon-sulfur composite manufactured thereby, and an electrochemical device including the same.

### BACKGROUND ART

Rechargeable batteries have been increasingly demanded with the rapid development of portable electronic devices. In particular, batteries having high energy density have been continuously demanded with requirement of small, light and thin portable electronic devices. In addition, low-priced, stable and eco-friendly batteries have been required.

A lithium-sulfur battery is a rechargeable battery that uses a sulfur-based compound having sulfur-sulfur (S—S) bonds as a positive active material and uses a carbon-based material, in which insertion and de-insertion of a metal ion (e.g., a lithium ion) occur, or an alkali metal (e.g., lithium) as a negative active material. The lithium-sulfur battery stores and generates electrical energy using an oxidation-reduction reaction. In other words, the S—S bonds break during the reduction reaction (a discharge process), so an oxidation number of sulfur decreases. The oxidation number of sulfur increases during the oxidation reaction (a charge process), so the S—S bonds are formed again.

However, no lithium-sulfur battery system is yet available commercially. This is because a real battery capacity is very lower than a theoretical capacity due to a low ratio of the amount of sulfur used during an electrochemical oxidation-reduction reaction in the battery to the amount of inputted sulfur when sulfur is used as an active material. In addition, since sulfur is generally non-conductive, an electrical conductive material capable of providing electrochemical reaction sites should be used to cause the electrochemical reaction. As shown in U.S. Pat. Nos. 5,523,179 and 5,582,623, a known positive electrode structure using sulfur has sulfur used in a positive active material layer (a compound) and carbon powder used as a conductive material that exist independently of each other and are simply mixed with each other. However, during charge and discharge processes, sulfur of this structure may become a liquid poly-sulfide and the liquid poly-sulfide may be then inputted into an electrolyte to break the electrode structure. Thus, capacity and lifetime characteristics of the lithium-sulfur battery may be deteriorated.

To solve the above problem, an additive agent adsorbing sulfur may be added into positive active material slurry to delay an outflow of the positive active material. An active carbon fiber was used as an adsorbent for the above purpose in Japanese Patent laid-open publication No. H9-147868 (Jun. 6, 1997). In addition, in U.S. Pat. No. 5,919,587, the positive active material was embedded in a transition metal chalcogenide having a highly porous, fibrous and ultrafine sponge-like structure or was encapsulated by the transition metal chalcogenide.

However, the above conventional arts did not greatly improve the capacity and lifetime characteristics of the lithium-sulfur battery.

### DISCLOSURE OF THE INVENTION

### Technical Problem

The present invention provides a new method for manufacturing a carbon-sulfur composite.

The present invention also provides a carbon-sulfur composite manufactured by the method and an electrochemical device including the same.

### Technical Solution

The present invention provides a method for manufacturing a carbon-sulfur composite. The method includes:

generating an organic silica fine particle;

mixing and hydrothermally reacting the organic silica fine particle with a carbon precursor to form a suspension;

after drying the suspension, thermally treating the suspension in an inert-gas atmosphere;

immersing the thermally treated particle in an etching solution to remove inner silica;

thermally treating the organic silica fine particle from which the inner silica is removed, thereby manufacturing a hollow carbon particle; and

impregnating sulfur into the hollow carbon particle.

In an embodiment of the present invention, generating the organic silica fine particle may include: adding an organic silane and a basic catalyst into a solvent to carry out an organic silane condensation polymerization reaction.

In an embodiment of the present invention, the organic silane may be selected from a group consisting of 3-mercaptopropyl trimethoxy silane (MPTMS), phenyl trimethoxy silane (PTMS), vinyl trimethoxy silane (VTMS), methyl trimethoxy silane (MTMS), 3-aminopropyl trimethoxy silane (APTMS), 3-glycidyloxylpropyl trimethoxy silane (GPTMS), (3-trimethoxysilyl)propylmethacrylate (TMSPMA), and 3-(trimethoxysilyl)propylisocyanate (TMSPI).

In an embodiment of the present invention, the solvent may be selected from a group consisting of water, alcohol, and a mixture thereof.

In an embodiment of the present invention, the basic catalyst may be selected from a group consisting of a compound containing an amino group and a hydroxyl group, an ammonia water solution, a sodium hydroxide water solution, an alkylamine water solution, and any mixture thereof.

In an embodiment of the present invention, the etching solution may use HF, a mixture solution of HF and NaOH, or a mixture solution of HF and KOH. A ratio of the etching solution to 1 weight part of the carbon-sulfur composite may be in a range of 0.1 weight part to 2.0 weight parts when the inner silica is etched.

In an embodiment of the present invention, the carbon precursor may be selected from a consisting of a polymer manufactured by an addition polymerization reaction using a monomer (e.g., divinylbenzene, acrylonitrile, vinyl chloride, vinyl acetate, styrene, methacrylate, methylmethacrylate, ethylene glycol dimethacrylate, urea, melamine, or CH₂═CRR′ (where R and R′ denote an alkyl group or an aryl group)) and an initiator (e.g., azobisisobutyronitrile (AIBN), t-butyl peracetate, benzoyl peroxide (BPO), acetyl peroxide, or lauryl peroxide), a polymer manufactured by a condensation polymerization reaction using a monomer (e.g., phenol-formaldehyde, phenol, furfuryl alcohol, resorcinol-formaldehyde (RF), aldehyde, sucrose, glucose, or xylose) and an acid catalyst (e.g., sulfuric acid or hydrochloric acid), and mesophase pitch. In another embodiment, the carbon precursor may be another carbon precursor that forms graphitic carbon by a carbonization reaction. In still another embodiment, the carbon precursor may be selected from a group consisting of sucrose, glucose, and xylose.

In an embodiment of the present invention, impregnating the sulfur into the hollow carbon particle may include: separately providing the hollow carbon particle and the sulfur in a reactor; and filling an inside of the hollow carbon particle with the sulfur under vacuum. The reactor may be a Y-shaped glass tube. After the hollow carbon particle and sulfur are respectively provided into separated glass tubes of the Y-shaped glass tube, the inside of the Y-shaped glass tube may be vacuumized and a thermal treatment may be performed to impregnate the sulfur into the hollow carbon particle.

In an embodiment of the present invention, impregnating the sulfur into the hollow carbon particle may include: separately providing the hollow carbon particle and the sulfur in the reactor at a ratio of sulfur that is in a range of 50 weight parts to 300 weight parts per 100 weight parts of the hollow carbon particle; and vacuumizing the inside of the reactor. If the ratio of the sulfur is lower than 50 weight parts, the amount of the sulfur provided in the hollow carbon may lack. Even though the ratio of the sulfur is greater than 300 weight parts, the amount of sulfur filled into the hollow carbon may not increase.

The present invention also provides a carbon-sulfur composite manufactured by the manufacturing method of the prevent invention.

In an embodiment of the present invention, the carbon-sulfur composite may contain sulfur of 50 wt. % to 60 wt. % in its inner hollow.

In an embodiment of the present invention, a diameter of the carbon-sulfur composite may be in a range of 50 nm to 1 μm. The diameter of the carbon-sulfur composite may be equal to a diameter of the hollow carbon ball. Even though the sulfur is provided into the hollow carbon ball, the diameter of the hollow carbon ball may not be changed.

In an embodiment of the present invention, the carbon-sulfur composite may have two weight-loss temperatures in thermogravimetric analysis. A first weight-loss temperature may be in a range of 250 C.° to 270 C.°, and a second weight-loss temperature may be in a range of 400° C. to 450 C.°. The first weight-loss temperature is near a melting point of the sulfur, and the sulfur existing on a surface of the carbon-sulfur composite melts at the first weight-loss temperature. The second weight-loss temperature is a temperature at which the sulfur existing inside the carbon-sulfur composite melts.

The present invention also provides an electrochemical device including the carbon-sulfur composite. In an embodiment, the electrochemical device may be a lithium-sulfur battery.

An organic solvent used as a non-aqueous electrolyte of the lithium-sulfur battery according to the present invention may include, but not limited to, polyether. The polyether may include at least one of, but not limited to, diethylene glycol dimethyl ether, triethylene glycol dimethyl ether, tetraethylene glycol dimethyl ether, a high-quality glyme, ethylene glycol divinylether, diethylene glycol divinylether, triethylene glycol divinylether, dipropylene glycol dimethylene ether, and butylene glycol ether. The tetraethylene glycol dimethyl ether and lithium polysulfide have high ionic conductivities and low volatility, so they may be used.

In addition, in the non-aqueous electrolyte rechargeable battery of the present invention, a lithium salt added into a non-aqueous electrolyte solution may use a known material used as an electrolyte of a general non-aqueous electrolyte rechargeable battery. For example, the lithium salt may be one selected from a group consisting of LiBF₄, LiPF₆, LiCF₃SO₃, LiC₄F₉SO₃, LiN(CF₃SO₂)₂, LiN(C₂F₅SO₂)₂, LiN(CF₃SO₂)(COCF₃), and LiAsF₆.

Moreover, in the non-aqueous electrolyte rechargeable battery of the present invention, a material occluding and releasing lithium used as a negative electrode may use a generally known material (e.g., a lithium metal, a lithium alloy, or a carbon material such as graphite) of a general non-aqueous electrolyte rechargeable battery. However, to realize the non-aqueous electrolyte rechargeable battery with a high energy density, silicon alloyed with lithium may be used as the material occluding and releasing lithium, as disclosed in Korean Patent application No. 10-2011-0028246 filed by the applicant of the present invention.

### Advantageous Effects

Since the carbon-sulfur composite manufactured by the carbon-sulfur composite manufacturing method of the present invention includes the carbon ball having the inner hollow which is uniformly filled with sulfur, the sulfur content increases. Thus, the capacity characteristic increases. In addition, even though sulfur is changed into a liquid state during charge and discharge processes, an electrode structure is not destroyed to realize a stable lifetime characteristic.

### BRIEF DESCRIPTION OF THE DRAWINGS

FIG. 1A shows a scanning electron microscope (SEM) photograph of a hollow carbon obtained in an embodiment of the present invention, and FIG. 1B shows a SEM photograph of a carbon-sulfur composite manufactured in an embodiment of the present invention.

FIG. 2 shows a measured result of thermogravimetric analysis (TGA) of a carbon-sulfur composite obtained in an embodiment of the present invention.

FIG. 3 shows measured results of a charge/discharge characteristic and a lifetime characteristic of a battery manufactured in an embodiment of the present invention.

### BEST MODE FOR CARRYING OUT THE INVENTION

Hereinafter, exemplary embodiments of the present invention and a comparison example will be described in detail. However, it should be noted that the present invention is not limited to the following exemplary embodiments and may be implemented in various forms. Accordingly, the exemplary embodiments are provided only to disclose the present invention and let those skilled in the art know the category of the present invention.

### Embodiment Example 1

### Manufacture of Hollow Carbon Ball

100 g of water was added into a 250 ml beaker, and 1 g of 3-mercaptopropyl trimethoxy silane (MPTMS, Si(OCH₃)₃—(CH₂)₃—SH) was also added into the beaker. They were stirred at room temperature for one hour.

Subsequently, after 0.1 ml of NH₄OH was slowly added into the reactor, they were stirred at the same temperature for 5 hours. A reactant obtained after completion of the reaction was dispersed in water (50 ml), and sucrose was then added into the water in which the reactant was dispersed. The water, the reactant, and the sucrose were stirred and were then transferred to a Teflon container. The materials in the Teflon container were reacted with each other by a hydrothermal reactor at 170° C. for 5 hours.

Next, an obtained reactant was filtered and was then cleaned three times with water and ethanol. The cleaned reactant was dried and was then thermally treated at 1000 C.° to manufacture a silica-carbon ball.

Subsequently, the silica-carbon ball was stirred in a HF water solution for 24 hours to remove silica by etching, and then, a drying process was performed at 100° C. for 12 hours, thereby manufacturing a hollow carbon ball.

### Embodiment Example 2

### Manufacture of Carbon-Sulfur Composite

The hollow carbon ball obtained by the embodiment example 1 and sulfur was thermally treated at a mass ratio of 1:3 under vacuum at 600 C.° in a Y-shaped glass tube for 4 hours. Thus, sulfur was provided into the inside of the hollow carbon ball, thereby manufacturing the carbon-sulfur composite.

### Embodiment Example 3

### Manufacture of Electrode and Battery

The carbon-sulfur composite manufactured by the embodiment example 2, a carbon black conductive material, and a polyethylene oxide binder were mixed at a ratio of 60:20:20 in an acetonitrile solvent to manufacture slurry. The manufactured slurry was coated with a thickness of 40 μm on an aluminum foil, and the aluminum foil coated with the slurry was pressed by a roller. Thereafter, the aluminum foil coated with the slurry was dried at 50° C. to remove a residual solvent.

A lithium-sulfur battery was manufactured using the obtained positive electrode plate and a lithium foil negative electrode. At this time, an electrolytic solution was obtained by dissolving LiSO₃CF₃ in tetraethyleneglycol dimethylether (TEGDME) at a ratio of 4:1.

### Experimental Example 1

### Scanning Electron Microscope (SEM) Analysis

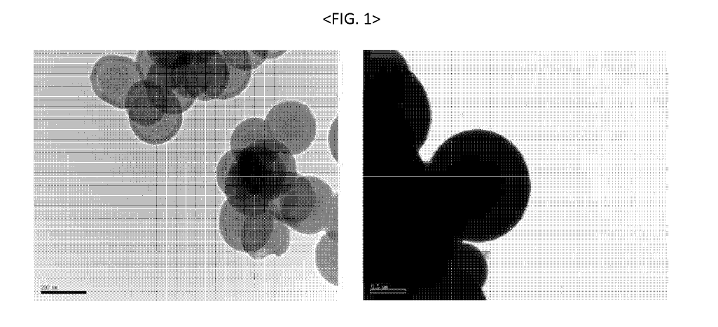

A SEM photograph of the hollow carbon obtained in the embodiment example 1 was shown in FIG. 1A, and a SEM photograph of the carbon-sulfur composite manufactured in the embodiment example 2 was shown in FIG. 1B.

As shown in FIG. 1B, it is confirmed that the hollow carbon ball and sulfur are mixed with each other and are thermally treated to manufacture the carbon-sulfur composite having the hollow carbon of which an inner hollow is filled with sulfur.

### Experimental Example 2

### Thermogravimetric Analysis (TGA)

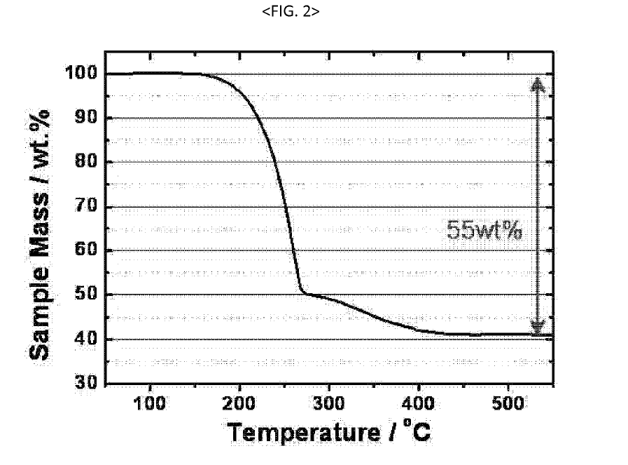

The TGA of the carbon-sulfur composite manufactured in the embodiment example 2 was measured to confirm a content of sulfur included in the carbon-sulfur composite and a temperature of a loss point in weight variation of the sulfur. The TGA measurement was performed under a nitrogen condition, and the temperature steadily rose at a rate of 10° C./min to measure variation of a weight. A resultant graph of the TGA measurement was shown in FIG. 2.

As shown in FIG. 2, it is confirmed that the inside of the hollow carbon is filled with sulfur and the carbon-sulfur composite includes sulfur of 50 wt. % to 90 wt. %.

### Experimental Example 3

### Evaluation of Charge/Discharge Characteristic of Battery

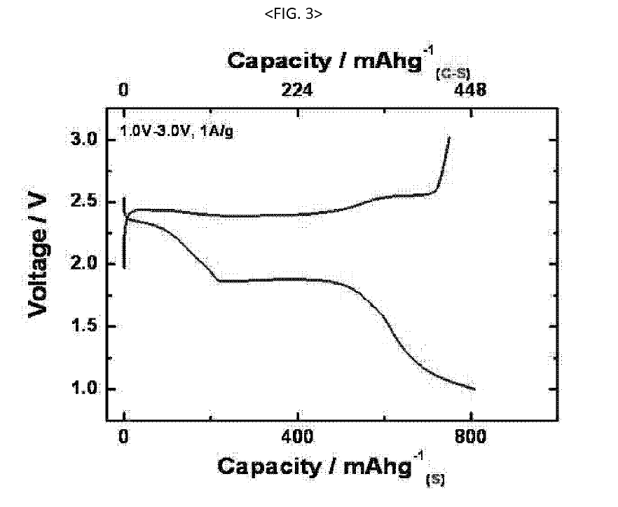

A charge/discharge experiment according to a current density was conducted to the battery manufactured in the embodiment example 3, and the result of the experiment was shown in FIG. 3.

### INDUSTRIAL APPLICABILITY

Since the carbon-sulfur composite manufactured by the carbon-sulfur composite manufacturing method of the present invention includes the carbon ball having the inner hollow which is uniformly filled with sulfur, the sulfur content increases. Thus, the capacity characteristic increases. In addition, even though sulfur is changed into a liquid state during charge and discharge processes, the electrode structure is not destroyed. Thus, the battery has a stable lifetime characteristic.

1. A method for manufacturing a carbon-sulfur composite, the method comprising:
generating an organic silica fine particle;
mixing and hydrothermally reacting the organic silica fine particle with a carbon precursor to form a suspension;
after drying the suspension, thermally treating the suspension in an inert-gas atmosphere;
immersing the thermally treated particle in an etching solution to remove inner silica;
thermally treating the organic silica fine particle from which the inner silica is removed, thereby manufacturing a hollow carbon particle; and
impregnating sulfur into the hollow carbon particle.

2. The method of claim 1, wherein generating the organic silica fine particle comprises:
adding an organic silane and a basic catalyst into a solvent to carry out an organic silane condensation polymerization reaction.

3. The method of claim 2, wherein the organic silane is selected from a group consisting of 3-mercaptopropyl trimethoxy silane (MPTMS), phenyl trimethoxy silane (PTMS), vinyl trimethoxy silane (VTMS), methyl trimethoxy silane (MTMS), 3-aminopropyl trimethoxy silane (APTMS), 3-glycidyloxylpropyl trimethoxy silane (GPTMS), (3-trimethoxysilyl)propylmethacrylate (TMSPMA), and 3-(trimethoxysilyl)propylisocyanate (TMSPI).

4. The method of claim 2, wherein the solvent is selected from a group consisting of water, alcohol, and a mixture thereof.

5. The method of claim 2, wherein the basic catalyst is selected from a group consisting of a compound containing an amino group and a hydroxyl group, an ammonia water solution, a sodium hydroxide water solution, an alkylamine water solution, and any mixture thereof.

6. The method of claim 1, wherein the etching solution uses HF, a mixture solution of HF and NaOH, or a mixture solution of HF and KOH.

7. The method of claim 1, wherein a ratio of the etching solution to 1 weight part of the carbon-sulfur composite is in a range of 0.1 weight part to 2.0 weight parts when the inner silica is etched.

8. The method of claim 1, wherein the carbon precursor is selected from a group consisting of sucrose, glucose, and xylose.

9. The method of claim 1, wherein impregnating the sulfur into the hollow carbon particle comprises:
separately providing the hollow carbon particle and the sulfur in a reactor; and
filling an inside of the hollow carbon particle with the sulfur by temperature rising and thermal treatment under vacuum.

10. The method of claim 9, wherein separately providing the hollow carbon particle and the sulfur in the reactor comprises:
separately providing the hollow carbon particle and the sulfur in the reactor at a ratio of sulfur that is in a range of 50 weight parts to 300 weight parts per 100 weight parts of the hollow carbon particle.

11. A carbon-sulfur composite manufactured by the method of claim 1.

12. The carbon-sulfur composite of claim 11, wherein the carbon-sulfur composite includes an inner hollow, and
wherein a weight ratio of sulfur disposed in the inner hollow is in a range of 50 weight parts to 60 weight parts per 100 weight parts of the carbon-sulfur composite.

13. The carbon-sulfur composite of claim 11, wherein a diameter of the carbon-sulfur composite is in a range of 50 nm to 1 μm.

14. The carbon-sulfur composite of claim 11, wherein the carbon-sulfur composite has two weight-loss temperatures in thermogravimetric analysis.

15. An electrochemical device comprising the carbon-sulfur composite of claim 11.

16. The electrochemical device of claim 15, wherein the electrochemical device is a lithium-sulfur battery that includes tetraethylene glycol dimethyl ether and lithium polysulfide that are used as an electrolyte.
